(19) United States
(12) Patent Application Publication
(10) Pub. No.: US 2025/0305895 A1
(43) Pub. Date: Oct. 2, 2025

(54) FORCE SENSOR AND SENSOR SYSTEM

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 19/078,753

(22) Filed: Mar. 13, 2025

(30) Foreign Application Priority Data
Mar. 29, 2024 (JP) 2024-057455

(51) Int. Cl. G01L 1/22

(52) U.S. Cl. CPC G01L 1/2262

(57) ABSTRACT

To check data outputted from a force sensor, in a real-time manner. The force sensor includes: a strain element; a first bridge circuit that includes a first strain gauge group provided on the strain element and that detects a force in a specific direction which acts on the strain element or a moment about a specific axis which acts on the strain element; a second bridge circuit that includes a second strain gauge group provided on the strain element and that detects a force in the same direction as the force detected by the first bridge circuit or a moment about the same axis as the moment detected by the first bridge circuit; and a wireless communication module that is connected to the second bridge circuit and that is configured to wirelessly transmit, to a first device, a signal outputted from the second bridge circuit.

### TECHNICAL FIELD

The present disclosure relates to a force sensor and a sensor system.

### BACKGROUND ART

Patent Literature 1 discloses a clamping device for fixing a fixation target to be processed. The clamping device includes a measurement communication module. The measurement communication module includes a wireless communication section that transmits, to the display device, data obtained by a strain gauge attached to an operation shaft member of the clamping device. The strain gauge is provided with a lead wire that is connected to the measurement communication module through an inside of the operation shaft member.

### CITATION LIST

### Patent Literature

### [Patent Literature 1]

Japanese Patent Application Publication Tokukai No. 2020-62711

### SUMMARY OF INVENTION

### Technical Problem

If it is possible to wirelessly transmit a signal outputted from a force sensor, a checker who is absent from a work site can check the signal outputted from the force sensor, in a real-time manner.

However, in robots that operate on the basis of output signals from force sensors, since strain gauges of the force sensors are connected to controllers of the robots, wireless communication modules for wirelessly transmitting data to other devices cannot be connected to the strain gauges of the force sensor. Further, it is impossible to employ a technology disclosed in Patent Literature 1, because the clamping device disclosed in Patent Literature 1 is not a device that operates on the basis of data detected by a strain gauge.

It is an object of an aspect of the present disclosure to check data outputted from a force sensor, in a real-time manner.

### Solution to Problem

In order to attain the foregoing object, a force sensor in accordance with an aspect of the present disclosure includes: a strain element; a first bridge circuit that includes a first strain gauge group provided on the strain element and that detects a force in a specific direction which acts on the strain element or a moment about a specific axis which acts on the strain element; a second bridge circuit that includes a second strain gauge group provided on the strain element and that detects a force in the same direction as the force detected by the first bridge circuit or a moment about the same axis as the moment detected by the first bridge circuit; and a wireless communication module that is connected to the second bridge circuit and that is configured to wirelessly transmit, to a first device, a signal outputted from the second bridge circuit.

### Advantageous Effects of Invention

An aspect of the present disclosure enables check of data outputted from a force sensor, in a real-time manner.

### BRIEF DESCRIPTION OF DRAWINGS

FIG. 1 is a view illustrating a schematic configuration of one example of a sensor system in accordance with an embodiment of the present disclosure.

FIG. 2 is a schematic view schematically illustrating a configuration of a strain element included in a force sensor in accordance with the present disclosure.

FIG. 3 is a flowchart illustrating a flow of a control method carried out by a server of a sensor system.

### DESCRIPTION OF EMBODIMENTS

### (Overview of Sensor System 100)

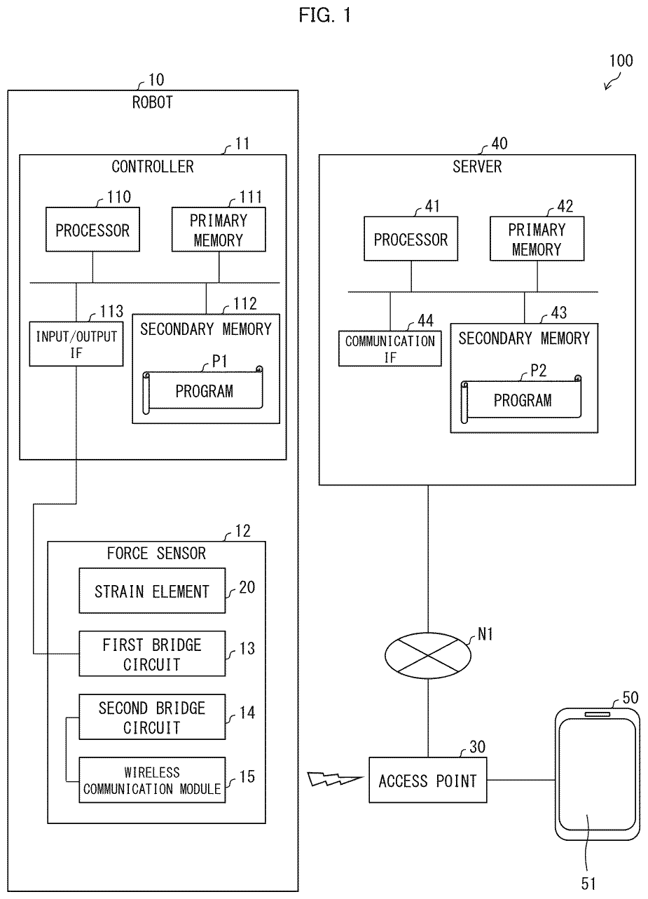

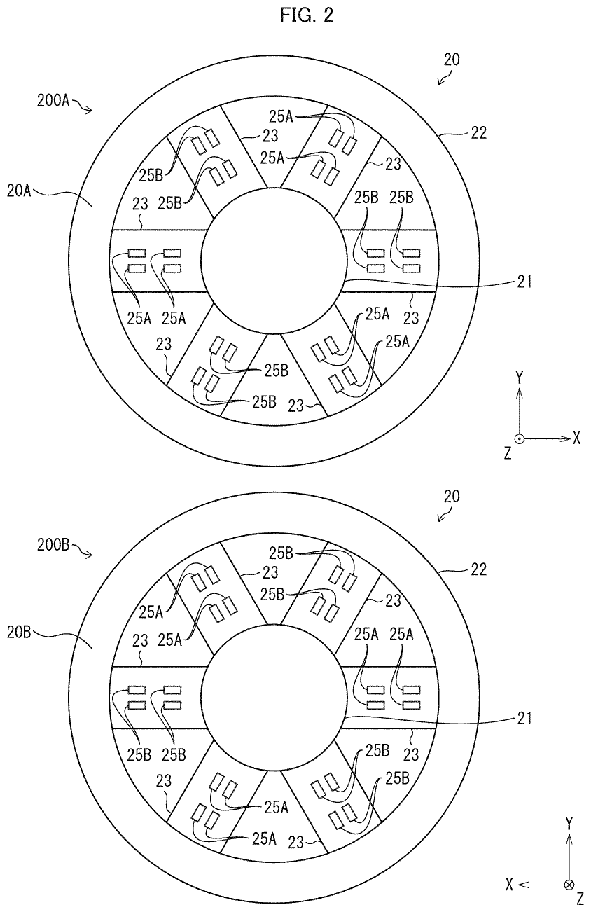

With reference to FIGS. 1 and 2, the following description will discuss a schematic configuration of a sensor system 100 in accordance with an embodiment of the present disclosure. FIG. 1 is a view illustrating a schematic configuration of one example of a sensor system 100 in accordance with an embodiment of the present disclosure. FIG. 2 is a schematic view schematically illustrating a configuration of a strain element 20 included in a force sensor 12.

The sensor system 100 includes the force sensor 12 and a server 40. The sensor system 100 may include a terminal device 50.

The force sensor 12 is installed in a robot 10. The robot 10 is a robot that operates on the basis of an output signal outputted from the force sensor 12. The robot 10 includes a controller 11 (which is one example of a second device in the claims).

The controller 11 controls the components included in the robot 10. The controller 11 includes a processor 110, a primary memory 111, a secondary memory 112, and an input/output IF 113. The processor 110, the primary memory 111, the secondary memory 112, and the input/output IF 113 are connected to each other via a bus. Examples of a device usable as the controller 11 include a personal computer (PC) and a PLC (programmable logic controller).

The secondary memory 112 stores a control program P1. The processor 110 loads, on the primary memory 111, the control program P1 stored in the secondary memory 112. The processor 110 then carries out processes in accordance with instructions included in the control program P1 loaded on the primary memory 111. Examples of a device usable as the processor 110 include a central processing unit (CPU). Examples of a device usable as the primary memory 111 include a semiconductor random access memory (RAM). Examples of a device usable as the secondary memory 112 include a hard disk drive (HDD).

The input/output IF 113 is an interface for communicating with the force sensor 12. The input/output IF 113 is an interface compatible with serial communication. The controller 11 receives an output signal from the force sensor 12 via the input/output IF 113 and controls operation of the robot 10 on the basis of the output signal received. As the input/output IF 113, for example, a universal serial bus (USB), an advanced technology attachment (ATA), or a small computer system interface (SCSI) may be used.

The force sensor 12 includes the strain element 20, a first bridge circuit 13, a second bridge circuit 14, and a wireless communication module 15. The force sensor 12 is a strain gauge sensor including the strain element 20.

In the present embodiment, the force sensor 12 is a six-axis force sensor which can detect forces (Fx, Fy, Fz) in an X-axis direction, a Y-axis direction, and a Z-axis direction and at the same time, detect moments (Mx, My, Mz) about the X-axis direction, the Y-axis direction, and the Z-axis direction. As illustrated in FIG. 2, it is assumed that the strain element 20 is disposed so that the two main surfaces thereof are parallel to the XY plane, and the surface on the positive side of the strain element 20 in the Z-axis direction is referred to as “first surface 20A”, whereas the main surface on the negative side of the strain element 20 in the Z-axis direction is referred to as “second surface 20B”.

The strain element 20 includes a core part 21, a frame part 22, and beam parts 23. The core part 21 is located in a center part of the strain element 20. The shape of the core part 21 is not particularly limited. The frame part 22 surrounds the core part 21. That is, the frame part 22 has a shape such that a center part thereof is removed. The beam parts 23 connect the core part 21 and the frame part 22. In the present embodiment, the six beam parts 23 are provided in a radial pattern with respect to the core part 21. Note that the number of the beam parts 23 only needs to be six or more.

As illustrated by the reference sign 200A and the reference sign 200B in FIG. 2, the strain element 20 is provided with a first strain gauge group consisting of a plurality of strain gauges 25A. Each of the strain gauges 25A is a strain gauge in which a thin metal film is used as a resistor. The thin metal film of the strain gauges 25A is covered with resin having flexibility. Examples of the metal of the thin metal film include a Cu (copper)-Ni (nickel)-based alloy and a Ni—Cr (chromium)-based alloy. Examples of the resin having flexibility include polyimide and epoxy resins. The strain gauges 25A each may be a strain gauge in which a thin semiconductor film is used as a resistor. The plurality of strain gauges 25A may include a strain gauge in which a thin metal film is used and a strain gauge in which a thin semiconductor film is used.

In the present embodiment, as illustrated by the reference sign 200A in FIG. 2, a plurality of strain gauges 25A are bonded to the first surface 20A of the strain element 20. Further, as illustrated by the reference sign 200B in FIG. 2, a plurality of strain gauges 25A are bonded to the second surface 20B of the strain element 20. More specifically, to each of the first surface 20A and the second surface 20B of one beam part 23, four strain gauges 25A are bonded. The strain gauges 25A each detect any of the forces (Fx, Fy, Fz) and moments (Mx, My, Mz) which act on the strain element 20. The strain gauges 25A may be each bonded to the strain element 20 in a position suitable for detecting the forces (Fx, Fy, Fz) and moments (Mx, My, Mz) which act on the strain element 20.

Further, the strain element 20 includes a second strain gauge group consisting of a plurality of strain gauges 25B. Each of the strain gauges 25B is a strain gauge having the same configuration to that of the strain gauge 25A. The strain gauges 25B are bonded to the same strain element 20 to which the strain gauges 25A are bonded.

In the present embodiment, as illustrated by the reference sign 200A in FIG. 2, a plurality of strain gauges 25B are bonded to the first surface 20A of the strain element 20. Further, as illustrated by the reference sign 200B in FIG. 2, a plurality of strain gauges 25B are bonded to the second surface 20B of the strain element 20. More specifically, to each of the first surface 20A and the second surface 20B of one beam part 23, four strain gauges 25B are bonded. The strain gauges 25B each detect any of the forces (Fx, Fy, Fz) and moments (Mx, My, Mz) which act on the strain element 20. The strain gauges 25B may be each bonded to the strain element 20 in a position suitable for detecting the forces (Fx, Fy, Fz) and moments (Mx, My, Mz) which act on the strain element 20.

The strain gauges 25A are bonded to three beam parts 23 of the six beam parts 23. The strain gauges 25B are bonded to the other three beam parts 23 of the six beam parts 23. The beam parts 23 to which the strain gauges 25A are bonded and the beam parts 23 to which the strain gauges 25B are bonded may be disposed alternately in a circumferential direction of the core part 21, as illustrated in FIG. 2.

Note that the strain gauges 25A and/or the strain gauges 25B may be bonded to side surfaces of the beam parts 23. The strain gauges 25A and/or the strain gauges 25B may be bonded to the frame part 22.

With reference back to FIG. 1, the first bridge circuit 13 includes the first strain gauge group. The first bridge circuit 13 is provided with a plurality of strain gauges 25A as appropriate. The first bridge circuit 13 may be constituted by a plurality of bridge circuits. For example, two first bridge circuits 13 may be provided to each of the beam parts 23 to which the strain gauges 25A are bonded. In this case, in one first bridge circuit 13, four strain gauges 25A bonded to a core part 21 side of one beam part 23 are disposed as appropriate. Further, in the other first bridge circuit 13, four strain gauges 25A bonded to a frame part 22 side of the one beam part 23 are disposed as appropriate.

The first bridge circuit 13 detects the forces (Fx, Fy, Fz) or moments (Mx, My, Mz) which act on the strain element 20. In the present embodiment, the first bridge circuit 13 detects the forces (Fx, Fy, Fz) which act on the strain element 20 and detects the moments (Mx, My, Mz) which act on the strain element 20. The plurality of first bridge circuits 13 may each detect a different force (Fx, Fy, Fz) and/or moment (Mx, My, Mz).

To the first bridge circuit 13, an output terminal connectable to a cable for, in a wired manner, transmitting a signal outputted from the first bridge circuit 13, to the controller 11. The cable is, for example, a cable used for serial communication. In the present embodiment, the first bridge circuit 13 and the controller 11 are connected by a serial communication cable in a wired manner.

The second bridge circuit 14 includes the second strain gauge group. The second bridge circuit 14 is provided with a plurality of strain gauges 25B as appropriate. The second bridge circuit 14 may be constituted by a plurality of bridge circuits. For example, two second bridge circuits 14 may be provided to each of the beam parts 23 to which the strain gauges 25B are bonded. In this case, in one second bridge circuit 14, four strain gauges 25B bonded to a core part 21 side of one beam part 23 are disposed as appropriate. Further, in the other second bridge circuit 14, four strain gauges 25B bonded to a frame part 22 side of the one beam part 23 are disposed as appropriate.

The second bridge circuit 14 detects the forces (Fx, Fy, Fz) or moments (Mx, My, Mz) which act on the strain element 20. That is, the second bridge circuit 14 detects the forces in the same directions as the forces detected by the first bridge circuit 13 or the moments about the same axes as the moments detected by the first bridge circuit 13. In the present embodiment, the second bridge circuit 14 detects the forces (Fx, Fy, Fz) which act on the strain element 20 and detects the moments (Mx, My, Mz) which act on the strain element 20. The plurality of second bridge circuits 14 may each detect a different force (Fx, Fy, Fz) and/or moment (Mx, My, Mz).

The wireless communication module 15 is a wireless communication module connected to the second bridge circuit 14. The wireless communication module 15 wirelessly transmits, to the server 40 and/or the terminal device 50, a signal outputted from the second bridge circuit 14. More specifically, the wireless communication module 15 wirelessly transmits, via the network N1, a signal outputted from the second bridge circuit 14, to the server 40. The wireless communication module 15 may be, for example, a wireless LAN module. The wireless LAN module is connected to the wireless LAN according to the communication standard of IEEE80.11. The wireless communication module 15 may be a short-range wireless communication module. The short-range wireless communication module is, for example, a communication module compliant with the Bluetooth (registered trademark) standard.

The sensor system 100 may include an access point 30. The wireless communication module 15 performs wireless transmission to the server 40 via the access point 30. The access point 30 constructs a wireless LAN network compliant with the IEEE80.11 standard.

The server 40 (which is one example of a first device in the claims) includes a processor 41, a primary memory 42, a secondary memory 43, and a communication IF 44. The processor 41, the primary memory 42, the secondary memory 43, and the communication IF 44 are connected to each other via a bus. Examples of a device usable as the server 40 include a workstation constituting a cloud server.

The processor 41, the primary memory 42, and the secondary memory 43 have similar configurations to those of the processor 110, the primary memory 111, and the secondary memory 112 described above, respectively. The secondary memory 43 stores a control program P2. The processor 41 carries out processes included in the control method M1 (described later) in accordance with instructions included in the control program P2.

The communication IF 44 is an interface for communicating with the wireless communication module 15 via the network N1. Examples of an interface usable as the communication IF 44 include an Ethernet (registered trademark) interface. Examples of the network N1 include a local area network (LAN). As the network N1, a personal area network (PAN), a campus area network (CAN), a metropolitan area network (MAN), a wide area network (WAN), a global area network (GAN), or an internetwork containing a combination thereof may be used. The internetwork may be an intranet, or may be an extranet, or may be the Internet.

The control program P2 for causing the processor 41 to carry out the control method M1 may be stored in a computer-readable non-transitory tangible storage medium. This storage medium can be the secondary memory 43 or another storage medium. For example, a tape, a disk, a card, a semiconductor memory, a programmable logic circuit, or the like can be used as said another storage medium.

The terminal device 50 (which is one example of a first device in the claims) is a terminal device used by a checker. Examples of a device usable as the terminal device 50 include various terminal devices such as smartphones, tablet personal computers (PC), or personal computers (PC). The terminal device 50 is connectable to the server 40 via the access point 30. The terminal device 50 includes a display 51 on which various data is displayed.

### [Flow of Control Method by Server]

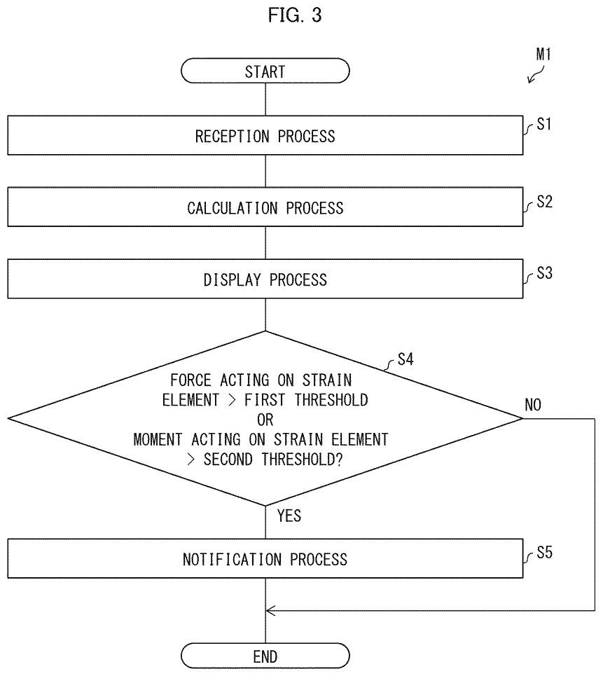

With reference to FIG. 3, the following description will discuss a flow of the control method M1 carried out by the server 40. FIG. 3 is a flowchart illustrating a flow of the control method M1 carried out by the server 40 of the sensor system 100.

As illustrated in FIG. 3, the control method M1 includes a reception process S1 and a display process S3. The control method M1 may include a calculation process S2, a determination process S4, and a notification process S5. The control method M1 is repeatedly carried out while the robot 10 is operating.

In the reception process S1, the processor 41 receives a signal outputted from the second bridge circuit 14 via the wireless communication module 15. More specifically, in the reception process S1, the processor 41 receives, via the communication IF 44, the signal outputted from the second bridge circuit 14.

In the calculation process S2, the processor 41 calculates values of the forces (Fx, Fy, Fz) or moments (Mx, My, Mz) which act on the strain element 20, on the basis of the signal outputted from the second bridge circuit 14 and received in the reception process S1.

In the display process S3, the processor 41 displays, on the display 51 of the terminal device 50 connected to the server 40, at least either of the forces (Fx, Fy, Fz) or moments (Mx, My, Mz) which act on the strain element 20 and which have been detected by the second bridge circuit 14. In the display process S3, the processor 41 displays the generated display screen on the display 51.

In the step S4, the processor 41 determines whether the values of the forces (Fx, Fy, Fz) calculated in the calculation process S2 exceed a first threshold or whether the values of the moments (Mx, My, Mz) calculated in the calculation process S2 exceed a second threshold. In a case where the values of the forces (Fx, Fy, Fz) calculated in the calculation process S2 are equal to or less than the first threshold and the values of the moments (Mx, My, Mz) calculated in the calculation process S2 are equal to or less than the second threshold (NO in S4), the processor 41 ends the control method M1. In a case where the values of the forces (Fx, Fy, Fz) calculated in the calculation process S2 exceed the first threshold or the values of the moments (Mx, My, Mz) calculated in the calculation process S2 exceed the second threshold (YES in S4), the processor 41 carries out the notification process S5.

In the step S4, the processor 41 may carry out the determination on the basis of a threshold value set for each of the forces (Fx, Fy, Fz) calculated in the calculation process S2. Further, the processor 41 may carry out the determination on the basis of a threshold value set for each of the moments (Mx, My, Mz) calculated in the calculation process S2.

In the notification process S5, the processor 41 notifies the terminal device 50 that the values of the forces (Fx, Fy, Fz) or the values of the moments (Mx, My, Mz) which are calculated in the calculation process S2 exceed the threshold value. In the notification process S5, the processor 41 may output an alert sound. In the notification process S5, the processor 41 may perform displaying that indicates an alert on a display screen displayed on the display 51 of the terminal device 50.

According to the force sensor 12, the forces (Fx, Fy, Fz) which act on the strain element 20 and which have been detected by the second bridge circuit 14 or the moments (Mx, My, Mz) which act on the strain element 20 and which have been detected by the second bridge circuit 14 are outputted to the server 40 and/or the terminal device 50 through wireless communication. This enables a checker to, even if the checker is present away from the work site, check data on a force in a specific direction which acts on the strain element 20 and which has been outputted by the force sensor 12 or a moment about a specific axis which acts on the strain element 20 and which has been outputted by the force sensor 12, in a real-time manner.

Further, the force sensor 12 includes the output terminal connected to the first bridge circuit 13, so that the signal outputted from the first bridge circuit 13 can be transmitted to the controller 11 via a cable. Furthermore, a signal outputted from the second bridge circuit 14 can be transmitted to the server 40 via the wireless communication module 15. This enables a checker to manage work quality or operation malfunction of the robot controlled by the controller 11 connected to a cable.

The wireless communication module is a wireless LAN module, so that it is possible to output, to the terminal device 50 existing within a communicable range of the wireless LAN, data on the forces (Fx, Fy, Fz) which act on the strain element 20 and which have been detected by the second bridge circuit 14 or the moments (Mx, My, Mz) which act on the strain element 20 and which have been detected by the second bridge circuit 14. This enables a checker who is present within the communicable range of the wireless LAN to check data on a force in a specific direction or a moment about a specific axis which have been outputted by the force sensor 12.

Aspects of the present invention can also be expressed as follows:

A force sensor in accordance with Aspect 1 of the present invention includes: a strain element; a first bridge circuit that includes a first strain gauge group provided on the strain element and that detects a force in a specific direction which acts on the strain element or a moment about a specific axis which acts on the strain element; a second bridge circuit that includes a second strain gauge group provided on the strain element and that detects a force in the same direction as the force detected by the first bridge circuit or a moment about the same axis as the moment detected by the first bridge circuit; and a wireless communication module that is connected to the second bridge circuit and that is configured to wirelessly transmit, to a first device, a signal outputted from the second bridge circuit.

According to the force sensor in accordance with Aspect 1, the force in a specific direction which acts on a strain element and which has been detected by the second bridge circuit or the moment about a specific moment which acts on the strain element and which has been detected by the second bridge circuit is outputted to the first device via the wireless communication. This enables a checker to, even if the checker is present away from the work site, check data on the force in a specific direction which acts on the strain element and which has been outputted by the force sensor or the moment about a specific axis which acts on the strain element and which has been outputted by the force sensor, in a real-time manner.

A force sensor in accordance with Aspect 2 of the present invention, in Aspect 1 above, may further include an output terminal that is connected to the first bridge circuit and that is connectable to a cable configured to, in a wired manner, transmit, to a second device different from the first device, a signal outputted from the first bridge circuit.

The force sensor in accordance with Aspect 2 enables a signal outputted from the first bridge circuit to be transmitted to the second device via the cable and enables a signal outputted from the second bridge circuit to be transmitted to the first device via the wireless communication module. This enables a checker to manage work quality or operation malfunction of the second device connected to a cable.

In a force sensor in accordance with Aspect 3 of the present invention, in Aspect 1 or 2 above, the wireless communication module may be a wireless LAN module.

According to the force sensor in accordance with Aspect 3, it is possible to output, to the first device existing within a communicable range of the wireless LAN, data on the force in a specific direction which acts on the strain element and which has been detected by the second bridge circuit or the moment about a specific axis which acts on the strain element and which has been detected by the second bridge circuit. This enables a checker who is present within the communicable range of the wireless LAN to check data on the force in a specific direction or the moment about a specific axis which have been outputted by the force sensor.

A sensor system in accordance with Aspect 4 of the present invention is a sensor system including the force sensor in accordance with any one of Aspects 1 to 3 above and a server, and the server may carry out: a reception process of receiving a signal outputted from the second bridge circuit via the wireless communication module; and a display process of displaying, on a display of a terminal device connected to the server, at least one of the force in the specific direction which acts on the strain element and which has been detected by the second bridge circuit or the moment about the specific direction which acts on the strain element and which has been detected by the second bridge circuit.

### SUPPLEMENTARY NOTE

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

1. A force sensor comprising:
a strain element;
a first bridge circuit that includes a first strain gauge group provided on the strain element and that detects a force in a specific direction which acts on the strain element or a moment about a specific axis which acts on the strain element;
a second bridge circuit that includes a second strain gauge group provided on the strain element and that detects a force in the same direction as the force detected by the first bridge circuit or a moment about the same axis as the moment detected by the first bridge circuit; and
a wireless communication module that is connected to the second bridge circuit and that is configured to wirelessly transmit, to a first device, a signal outputted from the second bridge circuit.

2. The force sensor according to claim 1, further comprising an output terminal that is connected to the first bridge circuit and that is connectable to a cable configured to, in a wired manner, transmit, to a second device different from the first device, a signal outputted from the first bridge circuit.

3. The force sensor according to claim 1, wherein the wireless communication module is a wireless LAN module.

4. A sensor system comprising the force sensor according to claim 1 and a server,
the server carrying out:
a reception process of receiving a signal outputted from the second bridge circuit via the wireless communication module; and
a display process of displaying, on a display of a terminal device connected to the server, at least one of the force in the specific direction which acts on the strain element and which has been detected by the second bridge circuit or the moment about the specific direction which acts on the strain element and which has been detected by the second bridge circuit.
